(19) United States
(12) Patent Application Publication
(10) Pub. No.: US 2020/0040212 A1
(43) Pub. Date: Feb. 6, 2020

(54) WATER BASED HEAT INSULATING COATING COMPOSITION AND A PROCESS FOR PREPARATION THEREOF

(71) Applicants: Sachin Shashikant JOSHI, Navi-Mumbai (IN); Kusum Sachin JOSHI, Navi-Mumbai (IN)

(72) Inventors: Sachin Shashikant JOSHI, Navi-Mumbai (IN); Kusum Sachin JOSHI, Navi-Mumbai (IN)

(21) Appl. No.: 16/600,652

(22) Filed: Oct. 14, 2019

Related U.S. Application Data
(63) Continuation-in-part of application No. 15/453,705, filed on Mar. 8, 2017.
(60) Provisional application No. 62/316,860, filed on Apr. 1, 2016.

(51) Int. Cl. C09D 151/00; C09D 7/61; C09D 7/63; C09D 7/40; C09D 5/02

(52) U.S. Cl. CPC C09D 151/003; C09D 7/61; C08K 5/0025; C09D 7/70; C09D 5/024; C09D 7/63

(57) ABSTRACT

The present disclosure relates to a fire resistant, corrosion protective, water proofing, energy saving, water based heat insulating coating composition and a process for its preparation. The coating composition comprises a graft copolymer emulsion, a colorant, and at least one reinforcing additive and a filler. The graft copolymer is grafted to synergize the properties shown by the polymers of four different specialty monomers which results in a coating that exhibits excellent heat insulation and other mechanical properties. The coating is useful as a heat insulating coating.

### CROSS REFERENCE TO RELATED APPLICATIONS

This application is a continuation-in-part application of U.S. Ser. No. 15/453,705 entitled “Fire resistant corrosion protective water proofing energy saving water based heat insulating coating composition” filed on Mar. 8, 2017, which claims priority to U.S. 62/316,860 entitled “WATER BASED HEAT INSULATING COATING COMPOSITION” filed on Apr. 1, 2016. The content of these applications are incorporated by reference as if fully set forth in their entireties.

### FIELD OF THE INVENTION

The present disclosure relates to coating compositions.

### Definitions

As used in the present disclosure, the following terms are generally intended to have the meaning as set forth below, except to the extent that the context in which they are used indicate otherwise.

TMTA—Trimethylolpropane Trimethacrylate

APS—Ammonium Persulphate

AIBN—Azobisisobutyronitrile

BPO—Benzoyl peroxide

Colorant—A composition comprising one or more organic or/and inorganic pigments. It may additionally include a dispersing medium, functional fillers, and water.

FRP—Fiber-reinforced plastic

Hard Segment monomer: A hard segment monomer is a monomer used to prepare coatings, which imparts toughness, stabilization against UV, resistance to scratch, and abrasion.

MA—Maleic Anhydride

Reinforcing additive—Reinforcing additive is a reinforcing material used in a coating composition. The reinforcing additive may be used either in raw form or mixed with a dispersing medium and water in which the reinforcing additive is dispersed.

Reinforcing monomer: A reinforcing monomer is a monomer used to prepare coatings, which imparts good adhesion properties, surface hardness, resistance to weathering and aging.

Soft Segment monomer: A soft segment monomer is a monomer used to prepare coatings, which imparts flexibility, resistance to impact, elongation, and moisture resistance and impermeability.

SRI—Solar Reflectivity Index

U value—U value is the overall heat transfer coefficient that describes how well a building element conducts heat or the rate of transfer of heat (in watts) through one square meter of a structure divided by the difference in temperature across the structure.

The phrase ‘total monomer’ in the present disclosure denotes the sum of the amounts of hard segment monomer, soft segment monomer, the first reinforcing monomer and the second reinforcing monomer in grams.

### BACKGROUND OF THE INVENTION

The background information herein below relates to the present disclosure but is not necessarily prior art.

Heat conduction into the interiors of building constructions during hot summers is a reason for increased energy consumption today. It is estimated that an additional 3 to 8 percent of the electricity demand in cities with populations greater than 1,00,000 is used to offset the heat conducted in the interiors. Studies indicate that people tend to avoid using air-conditioning systems at night if temperatures are below 25° C. Keeping temperatures below 25° C. at night in the interiors of buildings has a great potential to save large amounts of energy.

Using solid insulation materials under roofs, within concrete and sandwich panels are a good option to insulate the building interiors. However, they have constraints due to their difficulty in installation, increased costs and increased time for construction.

Offering a solution to this problem, many heat insulating coatings are being developed. They have a lot of advantages over solid insulation materials. They are easy to apply both in the interiors and the exteriors of buildings. They have been developed to exhibit excellent chemical resistance, resistance to UV, weathering properties and thermal stability. However, most heat insulating coatings use toxic solvents and are hence, not eco-friendly. With increasing environmental concerns, the industry is progressing towards using materials that cause minimal damage to the environment and are environment friendly.

Developing water based heat insulating coatings can be a great step forward in being eco-friendly due to their zero VOC content. However, most water based coatings show inadequate mechanical properties. They are susceptible to UV radiations, show poor resistance to chemicals and moisture, require frequent maintenance and are not applicable on all substrates. In regions of heavy rainfall, the water based coatings show poor performance. The concrete structures in those regions face severe leakage issues while the steel roofs undergo corrosion. This decreases the life of the structure calling for major reparation and maintenance involving huge expenditure.

Due to the high rise structure of buildings, fire safety has become a very important aspect to be kept in mind while construction. Water based coatings available today are simply not adequate to resist fires and hence limit their use.

Hence, there is a felt need to develop water based heat insulating coatings that mitigates the drawbacks mentioned herein above.

### OBJECTS OF THE INVENTION

Some of the objects of the present disclosure, which at least one embodiment herein satisfies, are as follows.

It is an object of the present disclosure to ameliorate one or more problems of the prior art or to at least provide a useful alternative.

An object of the present disclosure is to provide a water based heat insulating coating composition.

Another object of the present disclosure is to provide a water based heat insulating coating composition that has excellent mechanical properties and at the same time is eco-friendly.

Still another object of the present disclosure is to provide a water based heat insulating coating composition that is easy to apply on all substrates.

Yet another object of the present disclosure is to provide a process for preparation of a water based heat insulating coating composition.

Other objects and advantages of the present disclosure will be more apparent from the following description, which is not intended to limit the scope of the present disclosure.

### SUMMARY OF THE INVENTION

In accordance with an aspect of the present disclosure, a water based heat insulating coating composition is provided herein. The composition comprises 30% to 60% of a graft copolymer emulsion, 15% to 30% of a colorant, 5% to 15% of at least one reinforcing additive, 5% to 10% of a filler, and QS for 100%, water.

The graft copolymer emulsion comprises a hard segment monomer, a soft segment monomer, a cross-linking agent, a first reinforcing monomer, and a second reinforcing monomer. In addition, the emulsion further comprises a coalescing agent.

Typically, in the graft copolymer, the hard segment monomer is in an amount is in the range of 10% to 60%. The soft segment monomer is in an amount in the range of 10% to 60%, the first reinforcing monomer is in an amount in the range of 2% to 20% and the second reinforcing monomer is in an amount in the range of 1% to 10% of the graft copolymer.

Typically, the hard segment monomer is at least one selected from the group consisting of methacrylates, styrene, and alpha-methyl styrene. The soft segment monomer is at least one acrylate. The first reinforcing monomer is at least one selected from acetoacetoxy ethyl methacrylate (AAEM), and trimethylolpropane trimethacrylate. The second reinforcing monomer is at least one selected from styrene monomer, methacrylic acid, and maleic anhydride.

Typically, the filler is hollow glass spheres.

In accordance with another aspect of the present disclosure, a process for preparation of a water based heat insulating coating composition is provided herein.

A reactor is provided with stirring means and temperature control with multiple inlets. A graft copolymer emulsion is prepared by mixing water, an emulsifier, a buffer and a freeze-thaw agent in a reactor, at a temperature in the range of 25° C. to 40° C. and a speed of agitation in the range of 10 rpm to 50 rpm to obtain a mixture. The mixture is heated to a temperature in the range of 50° C. to 80° C., followed by addition of a hard segment monomer and at least one functional additive to obtain a first reaction mixture. Hard segment monomers in the first reaction mixture are polymerized by adding a mixture of polymerization initiator in water to the first reaction mixture at a feed rate in the range of 2 ml/min to 20 ml/min, to obtain a first polymer. The first polymer is reinforced by adding a first reinforcing monomer at a feed rate in the range of 2 ml/min to 20 ml/min to the first polymer to obtain a first reinforced polymer. At least one soft segment monomer is grafted onto the first reinforced polymer, by adding a first mixture comprising at least one soft segment monomer and at least one coalescing agent, at a feed rate in the range of 2 ml/min to 20 ml/min onto the first reinforced polymer and polymerizing the soft segment monomer to obtain a first graft polymer. The first graft polymer is reinforced by adding the first reinforcing monomer at a feed rate in the range of 2 ml/min to 20 ml/min to the first graft polymer to obtain a second reinforced polymer. At least one soft segment monomer onto the second reinforced polymer, by adding a second mixture comprising the second reinforcing monomer and at least one coalescing agent to the second reinforced polymer and stirring the resultant reaction mixture for a time period in the range of 2 to 6 hours, followed by cooling said resultant mixture to obtain the graft copolymer emulsion. The graft copolymer emulsion is isolated from the reactor in a vessel to obtain an isolated graft copolymer emulsion. A colorant is added to the isolated graft copolymer emulsion under stirring to obtain a colored emulsion. At least one reinforcing additive and a filler are added to the colored emulsion under stirring to obtain the water based heat insulating coating composition.

### BRIEF DESCRIPTION OF THE DRAWINGS

The water based heat insulating coating composition of the present disclosure will now be described with the help of the accompanying drawing, in which:

FIG. 1 illustrates a representational FIGURE of internal branching between the hard segment monomer, soft segment monomer, and the first and the second reinforcing monomers of the graft copolymer of the present disclosure to give a cross-linked like appearance.

### DETAILED DESCRIPTION OF THE INVENTION

Embodiments, of the present disclosure, will now be described with reference to the accompanying drawing.

Embodiments are provided so as to thoroughly and fully convey the scope of the present disclosure to the person skilled in the art. Numerous details, are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a,” “an,” and “the” may be intended to include the plural forms as well, unless the context clearly suggests otherwise. The terms “comprises,” “comprising,” “including,” and “having,” are open ended transitional phrases and therefore specify the presence of stated features, integers, steps, operations, elements, modules, units and/or components, but do not forbid the presence or addition of one or more other features, integers, steps, operations, elements, components, and/or groups thereof. The particular order of steps disclosed in the method and process of the present disclosure is not to be construed as necessarily requiring their performance as described or illustrated. It is also to be understood that additional or alternative steps may be employed.

The terms first, second, third, etc., should not be construed to limit the scope of the present disclosure as the aforementioned terms may be only used to distinguish one element, component, region, layer or section from another component, region, layer or section. Terms such as first, second, third etc., when used herein do not imply a specific sequence or order unless clearly suggested by the present disclosure.

Solvent based heat insulating coatings are not eco-friendly due to their release of dangerous VOCs into the environment. Water based heat insulating coatings in the state-of-the-art suffer from a lack of good mechanical properties and require frequent maintenance as their performance decreases with time.

The current water based coating compositions have constraints such as inadequate mechanical properties like toughness & scratch hardness. In addition, they are susceptible to UV radiations, have poor resistance to chemicals, inadequate moisture resistance, their performance reduces with time, require frequent maintenance, can-not be applied on all the substrates, and require complicated application process.

The present disclosure, therefore, provides a heat insulating coating composition that synergizes the advantages of both solvent based and water based heat insulating coatings. The desired performance properties of heat insulating coatings are:
Excellent Solar Reflectivity Index (SRI) and emissivity values
Resistance to UV radiation
Scratch resistance
Toughness
Chemical Resistance
Flexibility
Thermal stability
Easy application onto various substrates like metal, concrete, wood, paper, FRP and the like
Forming a stable emulsion
Fire resistance
Eco-friendliness
Single-pack system for ready use
Fast drying at ambient temperatures

In the coating composition, the type of polymer used determines the service performance of the coating.

The minimum required properties to be shown by the polymer are:

Heat Insulation Performance

Key parameters of heat insulation performance are SRI, emissivity of the material and thermal emittance of the coating (lambda values). SRI values should be higher, emissivity and emittance values should be lower for the polymer and finally the coating.

Protection Against Oxygen and Water

The film made by the polymeric coating should have excellent resistance to moisture and impermeability to oxygen.

UV Radiation Resistance

Many polymers when subject to UV attack from the sun, begin to degrade and lose their performance. The coating must be resistant to UV radiation.

Chemical Resistance

Many polymers are subject to attack by various chemicals like acids, alkalis, chlorine gas and ammonia gas. The coat surface gets corroded or the coat peels off when exposed to these chemicals. The polymer should resist attack from such chemicals.

Scratch and Abrasion Resistance

The outside and the inside of buildings are subject to various abuses either due to humans, stray animals, birds or other natural factors. These factors may cause scratches or abrasion due to which the underlying surface may get exposed and cause deterioration of the substrate. The polymer should, therefore, have excellent scratch resistance.

Freeze-Thaw Resistance

In regions subject to heavy rainfall and severe cold and hot weathers, freeze-thaw weathering can cause cracking of the polymeric coating films and the concrete structures beneath them. The accumulative effect of successive freeze-thaw cycles can be dangerous to the construction. The coat should therefore exhibit freeze-thaw resistance.

Thermal Stability

The coated surface may get exposed to very high temperatures. The coat should not soften, melt or break under such conditions. This will also peel off the film and expose the substrate beneath.

Flexibility and Fatigue Endurance

Metal undergoes continual expansion and contraction with the variation in temperature caused due to weather changes. The film should be flexible to absorb expansion and contraction without cracking. Most importantly, the coat should not reduce in performance due its flexibility.

Fire Resistance

Since coatings come in close proximity to human life, safety is of prime importance. In the event of fire, these coatings should not assist spreading the fire. They should resist the fire and protect the surface for a long time to minimize the loss of lives and property.

No single monomer based polymer (homopolymer) can fulfill all the desired properties. So, the idea is to prepare a graft copolymer that synergizes the properties shown by the polymers of four different specialty monomers—a hard segment monomer, a soft segment monomer, a first reinforcing monomer and a second reinforcing monomer and use the graft copolymer in the form of an emulsion in a coating composition. The four specialty monomers are so grafted as to form an internal branching similar to cross-linking which increases the resistance to environmental abuses. The final coating composition is capable of cross-linking which have enhanced performance over non-crosslinked coats. The cross-linking is achieved without the use of a hardener or crosslinking agent.

Hard segment monomers impart toughness, UV stabilization, scratch and abrasion resistance. Soft segment monomers impart flexibility, impact resistance, elongation, moisture resistance, and impermeability. A trifunctional monomer, as a cross-linking agent enhances effective cross linking at room temperature without heat and leads to a closely knit cross-linking structure. The reinforcing monomers impart good adhesion properties, surface hardness, weathering and aging resistance. The resultant graft copolymer will have a combination of all these properties and on curing will provide excellent heat insulation properties.

The desired properties of the coating composition is achieved by appropriate selection of the four monomers, designing the polymerization process to achieve a graft structure, selecting a colorant, a reinforcing additive and a filler for achieving the desired heat insulation properties.

In accordance with one aspect of the present disclosure, a water based heat insulating coating composition is provided herein. The composition comprises 30% to 60% of a graft copolymer emulsion, 15% to 30% of a colorant, 5% to 15% of at least one reinforcing additive, 5% to 10% of a filler, and QS for 100%, water.

The graft copolymer emulsion comprises a hard segment monomer, a soft segment monomer, a cross-linking agent, a first reinforcing monomer and a second reinforcing monomer. In addition to the graft copolymer, the emulsion contains a coalescing agent.

The colorant, essentially, comprises at least one organic or/and inorganic pigment.

In addition to the pigments, the colorant may contain a dispersing medium, functional fillers and water. The functional filler is at least one selected from the group consisting of mica, silica, barium sulphate, talc, china clay, calcium carbonate, ceramic, and zinc phosphate.

In an embodiment, the colorant comprises a pigment in the range of 10% to 60%, the dispersing medium in the range of 15% to 55%, the functional fillers in the range of 2% to 20% and water in the range of 10% to 50%. In a particular embodiment, the dispersing medium is a hydroxyl ethyl cellulose solution in water.

The reinforcing additives may be used in raw form or dispersed in a dispersing medium and water, before being added to the coating composition. In an embodiment, a mixture of 10% to 60% of the reinforcing additives, 15% to 55% of the dispersing medium and 2% to 20% water are used in the coating composition. In a particular embodiment, the dispersing medium is a hydroxyl ethyl cellulose solution in water.

In the graft copolymer, the amount of the hard segment monomer is in an amount in the range of 10% to 60%, and the amount of the soft segment monomer is in an amount in the range of 10% to 60%. In the copolymer, the weight ratio of the hard segment monomer to the soft segment monomer is in the range of 40:60 to 80:20. The amount of the first reinforcing monomer is in the range of 2% to 20% of the graft copolymer whereas the amount of the second reinforcing monomer is in the range of 1% to 10% of the graft copolymer.

The hard segment monomer is at least one selected from the group consisting of methacrylates, styrene and alpha-methyl styrene. The soft segment monomer is at least one acrylate. The first reinforcing monomer is at least one selected from acetoacetoxy ethyl methacrylate (AAEM), and trimethylolpropane trimethacrylate (TMTA). The second reinforcing monomer is at least one selected from styrene monomer, methacrylic acid and maleic anhydride. The emulsion further comprises a coalescing agent selected from the group consisting of tributyl phthalate (TBP) and glycols. The amount of the coalescing agent is in the range of 0.5% to 1.5% of each monomer.

Trimethylolpropane trimethacrylate, a trifunctional monomer, is a cross-linking agent that enhances effective cross linking at room temperature without heat, leading to a closely knit cross-linking structure.

The reinforcing additive is at least one selected from the group consisting of nano graphite, hollow glass spheres, nano zinc oxide, magnesium hydroxide, aluminum trihydrate, antimony trioxide, zirconium hydrogen phosphate, gadolinium zirconate and pentaerythritol.

In the coating composition of the present disclosure, micronized hollow glass spheres are incorporated as fillers. However, the hollow glass spheres are found to enhance the heat reflective properties and thermal insulation properties of the coating composition. Further, the coating composition of the present disclosure, comprising hollow glass spheres are also found to control heat losses.

In the coating composition of the present disclosure, zirconium hydrogen phosphate and gadolinium zirconate are incorporated as functional reinforcing fillers. These functional reinforcing fillers enhance the heat resistance, chemical resistance, abrasion resistance and fire resistance of the coating composition.

In accordance with another aspect of the present disclosure, a process for the preparation of a water based heat insulating coating composition is provided herein.

A reactor is provided with stirring means and temperature control with multiple inlets. Water, an emulsifier, a buffer and a freeze-thaw agent are then mixed at a temperature in the range of 25° C. to 40° C. and at an agitation speed in the range of 10 rpm to 50 rpm to obtain a mixture.

The emulsifier is selected from the group consisting of sodium laureth sulphate (SLES), sodium lauryl sulphate (SLS) and lecithin. The buffer is used to maintain the pH of the emulsion. In an exemplary embodiment, the buffer used is ammonium hydroxide. The buffer is used in an amount in the range of 0.1% to 0.8% of water fed into the reactor. In an exemplary embodiment, the freeze-thaw agent used is isopropyl alcohol (IPA).

The mixture is then heated to a temperature in the range of 50° C. to 80° C. followed by the addition of a hard segment monomer and at least one coalescing agent. The entire quantity of the hard segment monomer and the coalescing agent is added at once to obtain a first reaction mixture. The hard segment monomer is at least one selected from the group consisting of methacrylates, styrene, and alpha-methyl styrene.

The process temperature in the range of 70 to 80° C. leads to good initiation of the polymerization. Below 70° C., there is no initiation of polymerization and therefore no conversion. On the other hand above 80° C., the polymerization initiation is rapid and leads to unstable emulsion and form a gel.

In an embodiment, the coalescing agent is selected from the group consisting of tributyl phthalate (TBP) and glycols. The amount of the coalescing agent is in the range of 0.5% to 1.5% of the hard segment monomer.

Amount of coalescent agent in the range of 2 to 3%, leads to moderate to good film formation with a Tg in the range of 10 to 35. Below 2%, there is no film formation observed.

A polymerization initiator dissolved in water is then continuously added to the first reaction mixture, at a feed rate in the range of 2 ml/min to 20 ml/min to initiate polymerization of the hard segment monomer and to obtain a first polymer. The polymerization initiator is selected from the group consisting of ammonium persulphate, azobisisobutyronitrile, and benzoyl peroxide. The amount of the polymerization initiator used is in the range of 0.1% to 2.0% of the combined amount of the monomers.

Initiator concentrations in the range of 0.1% to 0.5% lead to formation of polymers with high molecular weights in the range of 50000 to 100000, which have good performance properties. Concentration above 0.5% resulted in formation of polymers with low molecular weights i.e. below 50000.

As the exotherm rises and the temperature of the reactor increases to a value in the range of 70° C. to 95° C., a first reinforcing monomer is added to the first polymer, at a feed rate in the range of 2 ml/min to 20 ml/min to reinforce the first reinforcing monomer onto the first polymer to obtain a first reinforced polymer. In an embodiment, the first reinforcing monomer is AAEM. In another embodiment, the first reinforcing monomer is trimethylolpropane trimethacrylate (TMTA). In yet another embodiment, the first reinforcing monomer is a mixture of AAEM and trimethylolpropane trimethacrylate (TMTA).

A first mixture comprising at least one soft segment monomer and at least one coalescing agent is added at a feed rate in the range of 2 ml/min to 20 ml/min to the first reinforced polymer to initiate grafting of the soft segment monomer onto the first reinforced polymer and to initiate polymerization of the soft segment monomer and to obtain a first graft polymer. The soft segment monomer is at least one selected from acrylates. In an embodiment, the coalescing agent is selected from the group consisting of TBP and glycols. The amount of the coalescing agent is in the range of 0.5% to 1.5% of the soft segment monomer.

The first reinforcing monomer is again introduced at a feed rate in the range of 2 ml/min to 20 ml/min to initiate grafting of the first reinforcing monomer onto the first graft polymer to obtain a second reinforced polymer.

A second mixture comprising the second reinforcing additive and a coalescing agent are added to the second reinforced polymer to initiate grafting of the second reinforcing monomer onto the second reinforced polymer. The second reinforcing monomer is maleic anhydride. In an embodiment, the coalescing agent is selected from the group consisting of TBP and glycols.

The grafting and polymerization reactions are continued for a time period in the range of 2 to 6 hours. The reactor is then cooled to a temperature in the range of 25° C. to 40° C. to obtain the graft copolymer emulsion comprising the hard segment monomer, the soft segment monomer, the first reinforcing monomer and the second reinforcing monomer. The graft copolymer emulsion from the reactor is then isolated in a separate vessel to obtain an isolated graft copolymer emulsion. The amount of the hard segment monomer in the graft copolymer is in the range of 10% to 60%. The amount of the soft segment monomer in the graft copolymer is in the range of 10% to 60%. The hard segment monomer:soft segment monomer ratio in the copolymer is in the range of 40:60 to 80:20. The amount of the first reinforcing monomer is in the range of 2% to 20% of the graft copolymer while the amount of the second reinforcing monomer is in the range of 1% to 10% of the graft copolymer.

This results in a copolymer with the backbone made of the hard segment polymer and the soft segment polymer is grafted onto the hard segment polymer backbone. The reinforcing monomers are grafted onto both the hard segment and the soft segment polymers.

The hard segment monomer and the soft segment monomer are taken in amounts such that the hard segment monomer:soft segment monomer ratio is in the range of 40:60 to 80:20. In this range, soft and smooth film with good adhesive properties is formed.

When the hard segment monomer:soft segment monomer ratio is between 40:60 to 20:80, either no film is formed or the film formed is brittle and has lower adhesive properties.

In another embodiment of the present disclosure, the hard segment monomer, the soft segment monomer and the reinforcing monomers are not added entirely but at continuous and controlled feed rates independent of each other. The feed rates independently vary in the range of 2 ml/min to 20 ml/min. In still another embodiment, the hard segment monomer is added at a continuous and controlled feed rate while the soft segment monomer is added all at once.

Various permutations and combinations in the amounts of the four monomers and their way of addition selected from discrete and continuous are permissible to result in graft copolymers having all possible grafting patterns and hence, properties.

The weight ratio of water to total monomer ratio (comprising hard segment monomer, soft segment monomer, first reinforcing monomer, and second reinforcing monomer) is one of the determining factors of the final properties of the coat. The amount of water and monomers are so chosen as to achieve a water:total monomer ratio in the range of 50:50 to 70:30. In this range the emulsion is stable.

When the water:total monomer ratio (comprising hard segment monomer, soft segment monomer, first reinforcing monomer, and second reinforcing monomer) is between 30:70 to 50:50, the Emulsion is unstable and therefore results in gel formation.

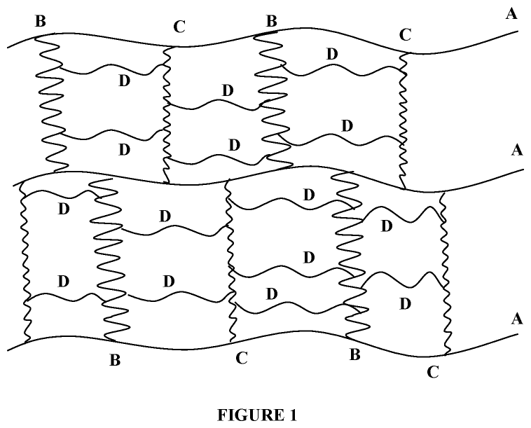

FIG. 1 illustrates a representational FIGURE of the structure of one such graft copolymer of the present disclosure wherein A represents a hard segment monomer, B represents a soft segment monomer, C represents the first reinforcing monomer and D represents the second reinforcing monomer.

A colorant is now added to the isolated graft copolymer emulsion in the vessel under stirring. The colorant, essentially, comprises at least one organic or/and inorganic pigment. It may comprise a dispersing medium, functional fillers and water in addition to the pigments, to help disperse the pigments in the graft copolymer emulsion. In an embodiment, the colorant comprises the pigments in the range of 10% to 60%, a dispersing medium in the range of 15% to 55%, the functional fillers in the range of 2% to 20% and water in the range of 10% to 50%.

At least one reinforcing additive is then added to the vessel containing the isolated graft copolymer emulsion and the colorant while stirring to obtain the water based heat insulating coating composition. The reinforcing additive may be used in raw form or mixed with a dispersing medium and water before being added to the graft copolymer emulsion. In an embodiment, a mixture comprising 10% to 60% of the reinforcing additives, 15% to 55% of the dispersing medium and 10% to 50% water is added to the graft copolymer emulsion.

The reinforcing monomer having concentration in the range of 0.4% to 0.6% and 10% to 12% showed improvements in the surface properties of the film of the coating composition of the present disclosure. Concentrations below these ranges showed no improvements in surface properties, whereas above these ranges the emulsion exhibited high exotherm and high viscosity, lead to unstable emulsion that formed gel.

The amounts of colorants and reinforcing additives are so taken such that the final water based heat insulating coating composition comprises colorants in the range of 15% to 30% of the coating composition and the reinforcing additives in the range of 5% to 25% of the coating composition. QS to make 100% of the coating composition is fulfilled by adding water.

The water based coating composition of the present disclosure has all the desired properties like fire resistance, corrosion resistance, water proofing, and heat insulation and hence is energy saving.

The coating composition of the present disclosure has following enhanced characteristic properties.
Heat Reflective & Heat Insulation properties:
   a) Solar Reflectivity Index->100
   b) Thermal Conductivity −0.022 W/Mk
Thermal Stability up to 250° C.
Chemical Resistance:
   Exposure to 35% Nitric Acid showed no Effect on film. No dusting, No colour change
Fire Resistance:
   Exposure to fire for 2 hours does not lead to fire spread.
Enhanced Corrosion Resistance
   Salt Spray performance increased from earlier 1000 hours to 2000 hours.
Scratch Resistance improvement
   Scratch hardness improved from 3 kg to 4.7 kg.

Therefore, the application of the coating composition of the present disclosure is not restricted only to heat insulation coating but it can also be used as fire protective anticorrosion coating.

In the present disclosure, the preparation of the coating composition is achieved through synergizing properties of four and more specialty polymers with reinforcing additives, thereby creating a graft structure of polymer chains to achieve all the desired performance and application properties. Thus, the present disclosure is based on selection & sourcing of specialty chemicals & monomers, unique design of polymerization process to achieve graft structure, specially developed pigmentation formulation with reinforcing additives and processes to suite the water based system for achieving desired heat insulation properties.

Therefore, according to the present disclosure the concept is to:
Use four monomers rather than one as in case of conventional system.
Select specialty monomers having Hard & Soft segments to suit the intended performance criteria.
Synergize the properties of four specialty monomers to achieve the minimum performance properties needed for industrial protective coating applications.
Graft the chains of four monomers so as to form internal branching similar to cross linking to further enhance the resistance to environmental abuses.
Design the polymerization process for creating Graft/Internal Branching structure.
Solidify the polymer film without hardener/cross linking agent.
Achieve Fast curing/drying properties with right combinations of ingredients.

The foregoing description of the embodiments has been provided for purposes of illustration and not intended to limit the scope of the present disclosure. Individual components of a particular embodiment are generally not limited to that particular embodiment, but, are interchangeable. Such variations are not to be regarded as a departure from the present disclosure, and all such modifications are considered to be within the scope of the present disclosure.

The present disclosure is further described in light of the following laboratory experiments which are set forth for illustration purpose only and not to be construed for limiting the scope of the disclosure. The following experiments can be scaled up to industrial/commercial scale and the results obtained can be extrapolated to industrial scale.

### EXPERIMENTS

### Experiment 1

Table 1 shows the various ingredients used in the preparation of a hard-soft-hard graft copolymer emulsion based coating composition.

TABLE 1
Various ingredients used in the preparation of a hard-soft-
hard graft copolymer emulsion based coating composition

| | | | |
|---|---|---|---|
| Part I | | Part II | |
| 1. | Distilled Water - 460 g | 1. | Distilled water - 52 g |
| 2. | Emulsifier - SLES - 10 g | 2. | Initiator - AIBN/BPO - 1.5 g |
| 3. | Buffer - NH₄OH - 4.6 g | | |
| 4. | Freeze-Thaw Agent - IPA - 3.3 g | | |
| Part III | | Part IV | |
| 1. | Methacrylate monomer- 128 g | 1. | Trimethylolpropane |
| 2. | Coalescing agent - TBP - 1.5 g | | trimethacrylate (TMTA) - 55 g |
| Part V | | Part VI | |
| 1. | Acrylate Monomer - 170 g | 1. | Trimethylolpropane |
| 2. | Coalescing agent - TBP - 1.2 g | | trimethacrylate (TMTA) - 55 g |
| Part VII | | | |

| | |
|---|---|
| 1. | Styrene Monomer - 85 g |
| 2. | Maleic Anhydride - 20 g |
| 3. | Methacrylic Acid - 17 g |
| 4. | Coalescing agent - TBP - 1.2 g |

Step 1

Part I was taken in a round bottom flask fitted with a stirrer, a condenser, feeding funnels, a temperature sensor in a water bath. Speed of agitation was maintained at 50 rpm. The temperature of the contents was raised from room temperature to 50° C. with constant stirring.

Step 2

Part III was added in the reaction in the entire amount followed by part II which was fed at a constant feed rate of 10 ml per minute.

Step 3

When the exotherm started building up, part IV was added at a temperature of reaction of 75° C. at a speed of 10 ml per minute.

Step 4

Once the addition of part IV was completed, part V was added at a reaction temperature of 75° C. at a speed of 10 ml per minute.

Step 5

Once the addition of part V was completed, part VI was added at a reaction temperature of 75° C. at a speed of 10 ml per minute.

Step 6

Once the addition of part VI was completed, part VII was added at a reaction temperature of 75° C. at a speed of 10 ml per minute.

Step 7

The reaction was allowed to continue at 75° C. for 6 hrs.

Step 8

The reactor was cooled to 35° C. after step 7.

Step 9

The reactants were drained and filtered under vacuum.

The copolymer thus formed was mixed with a colorant and a reinforcing additive to result in the coating composition.

### Experiment 2

Coating Process

The coating composition obtained from Experiment 1 was transferred into a conventional air assisted spray type pot gun. The air pressure and the volume as per the object profile were adjusted. A first coat was uniformly applied over the entire surface which was shot blasted to Sa21/2 level. The coat was allowed to dry for 30 minutes. A second coat was uniformly applied over the first coat which was allowed to dry for 30 minutes. The coated object was ready to handle/use after 60 minutes of coating.

### Experiment 3

Testing of the water based coating composition of experiment 1 was carried out by preparing a test panel. A mild steel panel of 1 to 1.5 mm thickness having a dimension of 150*100 mm was used for the test. It was shot blasted to Sa 21/2 level using the water based coating composition of experiment 1. Two coats of the coating composition were applied with an interval of 30 minutes and the test panel was allowed to flash dry for 60 minutes to achieve a final dry film thickness (DFT) of 80 to 90 microns. For testing, the coated panel was force dried at 90° C. for 30 minutes.

The following tests were conducted as per ASTM standards
A. Adhesion
B. Cracking resistance
C. Scratch Hardness
D. UV Radiation Resistance
E. Thermal Stability
F. Corrosion Resistance
G. Fire Resistance

The results of the various tests performed are presented in Table 2.

TABLE 2
Test results of Experiment 3

| Sr. | | | |
|---|---|---|---|
| No. | Performance Test | ASTM STD. | ACTUAL |
| 01 | Solar Reflectivity | — | 113 |
| | Emissivity | | 0.82 |
| 02 | Scratch Hardness | D - 7027 | No Exposure of |
| | (4.7 KG) | | Metal Substrate |
| | | | Passes the Test |
| 03 | Conical mandrel for | D - 522 | No film |
| | cracking resistance | | cracking or |
| | (4 mm) | | crazing |
| 04 | Adhesion | D - 3359 | No Peel-Off |
| 05 | Salt Spray Resistance | B - 117 | No Surface |
| | (Corrosion Resistance) | | Deterioration & |
| | 1000 HRS | | corrosion. |
| | (At 80 Microns DFT) | | |
| 06 | Thermal Stability at | D - 2243 | No effect on |
| | 200° C. for 24 hr | | coating surface. |
| 07 | UV Resistance | D-4587-05 | No Chalking |
| | 1000 hr | Uv-b-313 nm−1 | No color |
| | | | change |
| 08 | Resistance To Fire | IS-163 | Fire Spread |
| | | | Class I |

From Table 2, it can be seen that the Solar Reflectivity value is considerably high and the Emissivity value is low. This shows that the coating composition of Example 1 has high heat insulation properties. Also, it can be seen from the above test results that the coating has very good scratch hardness, cracking resistance, adhesion, corrosion resistance, thermal stability, UV resistance and fire resistance.

### Experiment 4

Two test panels were prepared by a method similar to Example 3. One test panel was coated with the coating composition of Experiment 1 and the other test panel was coated with a conventional acrylic emulsion coating. A comparison of properties of the two test panels is presented in Table 3.

TABLE 3
Comparison between a conventional coating
and the coating of the present disclosure

| | | | COATING |
|---|---|---|---|
| | | | COMPOSITION OF |
| SR. | PARAM- | CONVENTIONAL | THE PRESENT |
| NO. | ETERS | COATINGS | DISCLOSURE |
| 1. | Chemical | Water based | Graft Copolymer with |
| | composition | methacrylate polymer | specialty functional |
| | | with ceramic hollow | monomers and additives |
| | | spheres | |
| 2. | Application | Two pack System: | Single pack: ready to |
| | system | Requires mixing of | use. No mixing |
| | | paint &cross-linker | required. |
| 3. | SRI | 78 | 103 |
| 4. | Coating | 700-800 microns | 80 microns |
| | Thickness | | |
| 3. | Drying time | 4 to 6 hr | 15 minutes |
| 4. | Application | Only Concrete. Not | Applicable on all |
| | Surface | applicable on metal | surfaces like concrete, |
| | | | metal, wood, paper, |
| | | | cement boards and the |
| | | | like |
| 5. | Retention of | Poor. Degrades with | Excellent Retention |
| | Properties | time under UV | Properties. No effect of |
| | | radiation (Sunlight), | Sunlight, rains, |
| | | Rains, chemical attack | chemicals and abrasive |
| | | and abrasive action. | action. |
| 6. | Temperature | 5 to 6° C. | 10 to 14° C. |
| | Difference | | |
| 7. | Resistance | NIL | Excellent Resistance to |
| | to fire | | fire |
| 8. | Corrosion | Fair | Excellent |
| | Resistance | | |
| 9. | Waterproof | Fair | Excellent Waterproofing |
| | Properties | | properties |
| 8. | Maintenance | Not washable. Difficult | Zero maintenance. |
| | | to maintain. Oil stains | Easy to clean and |
| | | cannot be removed. | wash. Stain free. |

From table 3, it can be seen that as compared to the conventional coating composition, the composition of the present disclosure has far more superior properties. It is a single pack system with good heat insulation properties shown even by thin films. The drying time of the composition of the present disclosure is less and can conveniently be applied over a range of surfaces. The present coating shows excellent corrosion resistance properties, waterproofing, fire resistance and other mechanical properties. Due to improved heat insulation, the water based heat insulating coating is energy saving.

The water based heat insulating coating composition of the present disclosure has the following performance properties and application features:

Performance Properties:
1. Excellent values of SRI & Emissivity indicating excellent heat insulation
2. Excellent Resistance to UV Radiation
3. Excellent Corrosion Resistance
4. Very Good Resistance to Chemicals
5. Service Temperature range: −40° C. to 250° C.
6. Very good scratch hardness
7. Excellent Moisture resistance and
8. Resistance to Fire

Application Features:
1. It is a single pack, ready to use system. No separate mixing procedure is required;
2. Quick drying at room temperature—Test panels dry within 30 minutes without the need for oven baking;
3. Easy application procedure—Can be applied using conventional application tools like brush, roller, airless and air assisted spray gun; and
4. Excellent adhesion on all substrates like steel, wood, glass, concrete, FRP and asbestos.

### TECHNICAL ADVANCES AND ECONOMICAL SIGNIFICANCE

The present disclosure described herein above has several technical advantages including, but not limited to, the realization of a water based heat insulating coating composition that:
is fire resistant, corrosion protective, water proofing, energy saving and has excellent mechanical properties;
is eco-friendly; and
is easy to apply on all substrates.

The foregoing description of the specific embodiments so fully reveals the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

1. A water based heat insulating coating composition, said composition comprising:
(a) 30% to 60% of a graft copolymer emulsion, said emulsion comprising a hard segment monomer, a soft segment monomer, at least one first reinforcing monomer, and at least one second reinforcing monomer;
(b) 15% to 30% of a colorant;
(c) 5% to 15% of at least one reinforcing additive;
(d) 5% to 10% of a filler; and
(e) QS for 100%, water.

2. The coating composition as claimed in claim 1, wherein the weight ratio of said hard segment monomer to said soft segment monomer in said graft copolymer emulsion is in the range of 40:60 to 80:20.

3. The coating composition as claimed in claim 1, wherein said graft copolymer emulsion comprises said hard segment monomer in an amount in the range of 10% to 60%; said soft segment monomer in an amount in the range of 10% to 60%; said first reinforcing monomer in an amount in the range of 2% to 20%; and said second reinforcing monomer in an amount in the range of 1% to 10%.

4. The coating composition as claimed in claim 1, wherein said hard segment monomer is at least one selected from the group consisting of methacrylates, styrene and alpha-methyl styrene; said soft segment monomer is at least one acrylate; said first reinforcing monomer is at least one selected from acetoacetoxy ethyl methacrylate and trimethylolpropane trimethacrylate; and said second reinforcing monomer is at least one selected from styrene monomer, methacrylic acid and maleic anhydride.

5. The coating composition as claimed in claim 1, wherein said reinforcing additive is at least one selected from the group consisting of nano graphite, nano zinc oxide, magnesium hydroxide, aluminum trihydrate, antimony trioxide, zirconium hydrogen phosphate, gadolinium zirconate and pentaerythritol.

6. The coating composition as claimed in claim 1, wherein said filler is hollow glass spheres.

7. The coating composition as claimed in claim 1, wherein said emulsion comprises a coalescing agent selected from the group consisting of tributyl phthalate and glycols.

8. A process for preparing a water based heat insulating coating composition, said process comprising:
(a) preparing a graft copolymer emulsion by:
(i) mixing water, an emulsifier, a buffer and a freeze-thaw agent in a reactor, at a temperature in the range of 25° C. to 40° C. and at a speed of agitation in the range of 10 rpm to 50 rpm to obtain a mixture;
(ii) heating said mixture to a temperature in the range of 50° C. to 80° C., followed by addition of a hard segment monomer and at least one functional additive to obtain a first reaction mixture;
(iii) polymerizing said hard segment monomers, by adding a mixture of polymerization initiator in water to said first reaction mixture at a feed rate in the range of 2 ml/min to 20 ml/min, to obtain a first polymer;
(iv) reinforcing said first polymer, by adding said first reinforcing monomer at a feed rate in the range of 2 ml/min to 20 ml/min to the first polymer to obtain a first reinforced polymer;
(v) grafting at least one soft segment monomer onto said first reinforced polymer, by adding a first mixture comprising at least one soft segment monomer and at least one coalescing agent, at a feed rate in the range of 2 ml/min to 20 ml/min onto the first reinforced polymer and polymerizing said soft segment monomer to obtain a first graft polymer;
(vi) reinforcing said first graft polymer, by adding the first reinforcing monomer at a feed rate in the range of 2 ml/min to 20 ml/min to the first graft polymer to obtain a second reinforced polymer;
(vii) grafting at least one soft segment monomer onto said second reinforced polymer, by adding a second mixture comprising said second reinforcing monomer and at least one coalescing agent to the second reinforced polymer and stirring the resultant reaction mixture for a time period in the range of 2 to 6 hours, followed by cooling said resultant mixture to obtain said graft copolymer emulsion; and
(viii) isolating said graft copolymer emulsion from the reactor in a vessel to obtain an isolated graft copolymer emulsion;
(b) adding a colorant to said isolated graft copolymer emulsion under stirring to obtain a colored emulsion; and
(c) adding at least one reinforcing additive and a filler to the colored emulsion under stirring to obtain said water based heat insulating coating composition.

9. The process as claimed in claim 8, wherein the weight ratio of water to monomer is in the range of 50:50 to 70:30.

10. The process as claimed in claim 8, wherein said soft segment monomer and said hard segment monomer are added in a continuous and controlled manner at a feed rate in the range of 2 ml/min to 20 ml/min.

11. The process as claimed in claim 8, wherein said buffer is ammonium hydroxide and said emulsifier is selected from the group consisting of sodium laureth sulphate, sodium lauryl sulphate and lecithin.

12. The process as claimed in claim 8, wherein said polymerization initiator is selected from the group consisting of ammonium persulphate, azobisisobutyronitrile and benzoyl peroxide.

13. The process as claimed in claim 8, wherein said freeze-thaw agent is isopropyl alcohol.

14. The process as claimed in claim 8, wherein said graft copolymer emulsion obtained in step (vii) comprises:
i) 20 to 80% distilled water;
ii) 2 to 10% Sodium Lauryl sulphate as emulsifier;
iii) 0.3 to 0.6% NH₄OH as buffer;
iv) 1 to 20% freeze thaw agent;
v) 20 to 60% Methacrylate monomer as hard segment monomer and 1 to 10% coalescent agent, added in step (ii);
vi) 0.1 to 2% polymerization initiator and 10 to 50% g distilled water, added in step (iii);
vii) 2 to 20% trimethylolpropane trimethacrylate (TMTA) as first reinforcing agent, added in step (iv);
viii) 10 to 50% acrylate monomer as soft segment monomer and 1 to 10% coalescent agent, added as a first mixture in step (v);
ix) 2 to 20% trimethylolpropane trimethacrylate (TMTA) as first reinforcing agent, added in step (vi); and
x) a second mixture comprising 10 to 50% styrene monomer, 1 to 5% maleic anhydride, and 1 to 10% methacrylic acid, and 1 to 10% tributyl phthalate as coalescent agent, added in step (vii).

15. The process as claimed in claim 8, wherein said graft copolymer emulsion obtained in step (vii) comprises:
i) 44.23% distilled water;
ii) 0.94% Sodium Lauryl sulphate as emulsifier;
iii) 0.43% NH₄OH as buffer;
iv) 0.31% 2-butoxy ethanol as freeze thaw agent;
v) 12.09% Methacrylate monomer as hard segment monomer and 0.11% tributyl phthalate as coalescent agent, added in step (ii);
vi) 0.14% Azoisobutyronitrile as polymerization initiator and 4.9% distilled water, added in step (iii);
vii) 5.19% trimethylolpropane trimethacrylate (TMTA) as first reinforcing agent, added in step (iv);
viii) 16.07% acrylate monomer as soft segment monomer and 0.11% tributyl phthalate as coalescent agent, added as a first mixture in step (v);
ix) 5.19% trimethylolpropane trimethacrylate (TMTA) as first reinforcing agent, added in step (vi); and
x) a second mixture comprising 8.03% styrene monomer, 2% maleic anhydride, and 1.61% methacrylic acid, and 0.11% tributyl phthalate as coalescent agent, added in step (vii).
